(19) United States
(12) Patent Application Publication
(10) Pub. No.: US 2020/0177769 A1
(43) Pub. Date: Jun. 4, 2020

(54) APPARATUS, METHOD, AND STORAGE MEDIUM

(71) Applicant: CANON KABUSHIKI KAISHA, Tokyo (JP)

(72) Inventor: Yoshitaka Sasaki, Kawasaki-shi (JP)

(21) Appl. No.: 16/690,847

(22) Filed: Nov. 21, 2019

(30) Foreign Application Priority Data
Nov. 30, 2018 (JP) 2018-225343

(51) Int. Cl. H04N 1/60; G01J 3/46

(52) U.S. Cl. CPC H04N 1/6008; G01J 3/46; H04N 1/6086

(57) ABSTRACT

An apparatus that generates a color profile based on color signal values obtained by imaging and measuring a plurality of color patches, includes a first acquisition unit configured to acquire a plurality of device-dependent color signal values obtained by imaging at least one of the color patches under a plurality of geometric conditions, the plurality of geometric conditions being based on an imaging direction of each of the color patches and a direction in which a light source emits light to each of the color patches, a second acquisition unit configured to acquire a plurality of device-independent color signal values obtained by measuring at least one of the color patches under the plurality of geometric conditions, and a generation unit configured to generate the color profile based on the plurality of device-dependent color signal values and the plurality of device-independent color signal values.

### BACKGROUND OF THE INVENTION

### Field of the Invention

The aspect of the embodiments relates to an image processing technology to generate a color profile.

### Description of the Related Art

Pixel values of an image obtained by imaging using an imaging apparatus are color signal values dependent on characteristics of a color filter of the imaging apparatus (hereinafter, referred to as device-dependent color signal values). For example, to evaluate a color of an imaged object, the device-dependent color signal values are converted into color signal values conforming to a common color space standard (hereinafter, referred to as device-independent color signal values). Conversion from the device-dependent color signal values to the device-independent color signal values is performed using data called a color profile that represents a color conversion rule. Japanese Patent Application Laid-Open No. 2004-23207 discusses a technology for generating a color profile with high color conversion accuracy by using a plurality of pieces of image data obtained through imaging of the color patch with different exposures and virtually increasing colors of the color patch to increase an information amount.

However, in a case where color conversion is performed on an image obtained by imaging an object having a color appearance that changes depending on an observation angle, if the color profile based on information obtained by imaging the object in one direction as discussed in Japanese Patent Application Laid-Open No. 2004-23207 is used, it is not possible to deal with change of the color appearance depending on the observation angle.

### SUMMARY OF THE INVENTION

According to an aspect of the embodiments, an apparatus that generates a color profile to convert device-dependent color signal values into device-independent color signal values based on color signal values obtained by imaging and measuring a plurality of color patches, includes a first acquisition unit configured to acquire a plurality of device-dependent color signal values obtained by imaging at least one of the color patches under a plurality of geometric conditions, the plurality of geometric conditions being based on an imaging direction of each of the color patches and a direction in which a light source emits light to each of the color patches, a second acquisition unit configured to acquire a plurality of device-independent color signal values obtained by measuring at least one of the color patches under the plurality of geometric conditions, and a generation unit configured to generate the color profile based on the plurality of device-dependent color signal values and the plurality of device-independent color signal values.

Further features of the disclosure will become apparent from the following description of exemplary embodiments with reference to the attached drawings.

### BRIEF DESCRIPTION OF THE DRAWINGS

FIG. 1 is a block diagram illustrating a hardware configuration of an image processing apparatus.

FIG. 2 is a block diagram illustrating a functional configuration of the image processing apparatus.

FIG. 3 is a flowchart illustrating processing performed by the image processing apparatus.

FIG. 4 is a flowchart illustrating processing to generate a color profile.

FIG. 5 is a flowchart illustrating processing to select data to be used to generate the color profile.

FIG. 6 is a diagram schematically illustrating a geometric condition used in measuring color and imaging.

FIG. 7 is a table schematically illustrating data obtained by measuring color and imaging.

FIG. 8 is a graph schematically illustrating the processing to select the data to be used to generate the color profile.

FIG. 9 is a flowchart illustrating the processing to select the data to be used to generate the color profile.

### DESCRIPTION OF THE EMBODIMENTS

Hereinafter, exemplary embodiments of the disclosure are described with reference to the drawings. The exemplary embodiments described below do not necessarily limit the scope of the disclosure. Further, not all combinations of features described in the exemplary embodiments are essential to solving means of the disclosure.

### <Existing Color Profile Generation Method and Existing Color Conversion>

First, an existing color profile generation method and an existing color conversion processing using a color profile are described. To generate a color profile, a color chart including a plurality of color patches each having a different color is imaged using an imaging apparatus. Then, pixel values (R, G, B) corresponding to each of the color patches are acquired from the image obtained by imaging. Further, color signal values (X, Y, Z) are acquired by measuring each of the color patches using a colorimeter. As a result, correspondence relationship between the RGB values (R, G, B) and the XYZ values (X, Y, Z) can be obtained for each of the color patches. Subsequently, coefficients (a₁₁ to a₃₃) in a matrix in the following expression (1) are derived based on the obtained correspondence relationship.

$$\begin{matrix}[ Expression 1 ] & \\ [ \begin{matrix}X \\ Y \\ Z\end{matrix} ] = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] [ \begin{matrix}R \\ G \\ B\end{matrix} ] & ( 1 )\end{matrix}$$

The coefficients can be derived through known optimization processing such as a least squares method, a steepest descent method, a Newton method, and a damped least squares (DLS) method. Data representing nine coefficients in a 3×3 matrix can be generated as a color profile by the above-described methods. In color conversion processing using the color profile, the pixel values (R, G, B) of the image obtained by imaging are converted into the XYZ values (X, Y, Z) based on the expression (1). Accordingly, the device-dependent color signal values can be converted into the device-independent color signal values. The color profile is not limited to the data representing the nine coefficients in the 3×3 matrix, and may be data representing coefficients in, for example, a 3×9 matrix or a 3×19 matrix. Further, the color profile is not limited to the data representing the coefficients in the matrix, and may be a lookup table (LUT) representing correspondence relationship between the RGB values (R, G, B) and the XYZ values (X, Y, Z). In a case where the color profile is the LUT, the device-dependent color signal values can be converted into the device-independent color signal values through interpolation processing using the correspondence relationship between the RGB values (R, G, B) and the XYZ values (X, Y, Z).

However, in the existing color profile generation method, the RGB values and the XYZ values obtained by imaging and measuring color in one direction are used. Thus, it is not possible to perform color conversion that deals with an object having a color appearance that changes depending on an observation angle, such as an object having a three-dimensional shape. Accordingly, in a first exemplary embodiment, a color profile is generated using color signal values obtained by imaging and measuring color under a plurality of geometric conditions.

### <Hardware Configuration of Image Processing Apparatus 1>

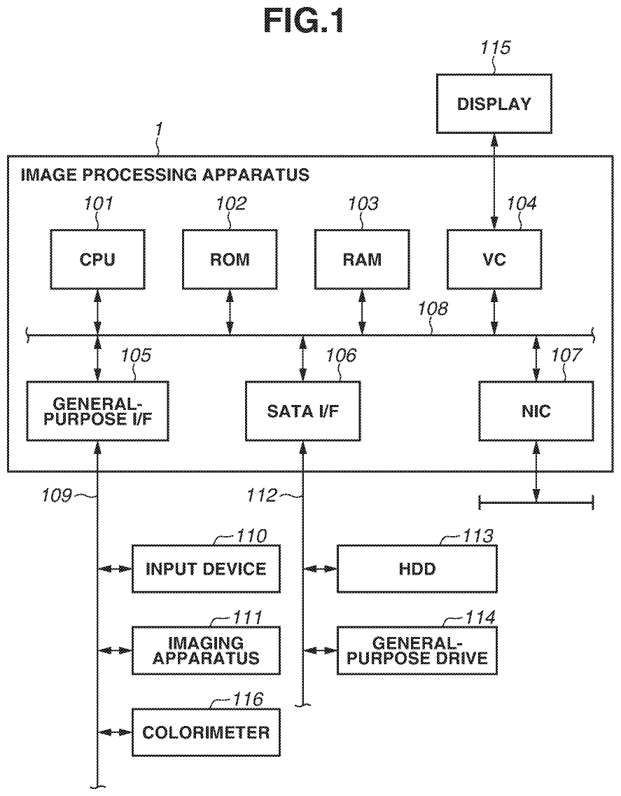

FIG. 1 is a block diagram illustrating a hardware configuration of an image processing apparatus 1. The image processing apparatus 1 includes a central processing unit (CPU) 101, a read-only memory (ROM) 102, and a random access memory (RAM) 103. The image processing apparatus 1 further includes a video card (VC) 104, a general-purpose interface (I/F) 105, a serial advanced technology attachment (SATA) I/F 106, and a network interface card (NIC) 107. The CPU 101 uses the RAM 103 as a work memory to execute an operating system (OS) and various kinds of programs stored in the ROM 102 and a hard disk drive (HDD) 113. The CPU 101 controls the components via a system bus 108. Processing in a flowchart described below is executed by the CPU 101 loading a program code stored in the ROM 102 or the HDD 113 to the RAM 103 and executing the loaded program code. A display 115 is connected to the VC 104. An input device 110 such as a mouse and a keyboard, an imaging apparatus 111, and a colorimeter 116 are connected to the general-purpose I/F 105 via a serial bus 109. The HDD 113 and a general-purpose drive 114 that performs reading and writing of various kinds of recording media are connected to the SATA I/F 106 via a serial bus 112. The NIC 107 performs input and output of information with an external apparatus. The CPU 101 uses the HDD 113 and various kinds of recording media mounted on the general-purpose drive 114 as a storage of various kinds of data. The CPU 101 displays a graphical user interface (GUI) provided by a program on the display 115, and receives input of a user instruction, etc. through the input device 110.

### <Functional Configuration of Image Processing Apparatus 1>

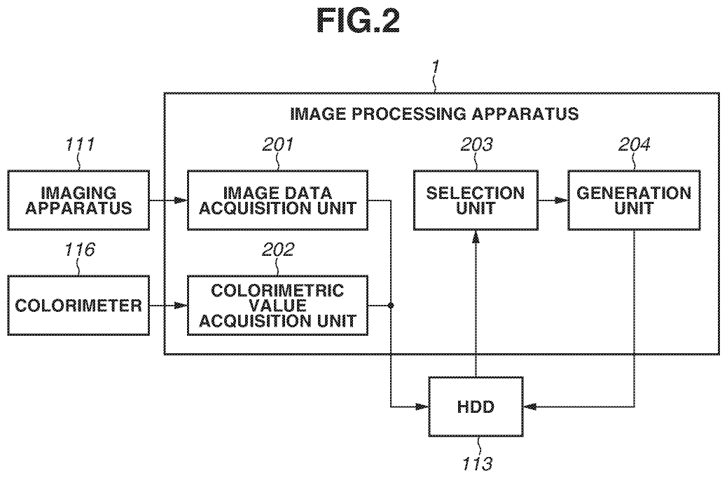

FIG. 2 is a block diagram illustrating a functional configuration of the image processing apparatus 1. The CPU 101 uses the RAM 103 as a work memory to read and execute a program stored in the ROM 102 or the HDD 113, thereby functioning as a functional configuration illustrated in FIG. 2. Not all of processing described below needs to be performed by the CPU 101, and the image processing apparatus 1 may be configured in such a manner that a part or all of the processing is performed by one processing circuit or a plurality of processing circuits other than the CPU 101.

The image processing apparatus 1 includes an image data acquisition unit 201, a colorimetric value acquisition unit 202, a selection unit 203, and a generation unit 204. The image data acquisition unit 201 acquires a plurality of pieces of image data that is obtained by imaging a color chart including a plurality of color patches each having a different color under a plurality of geometric conditions. The image data acquisition unit 201 acquires the plurality of pieces of image data from the imaging apparatus 111 and stores the plurality of pieces of image data in the HDD 113. The image data acquired by the image data acquisition unit 201 is color image data representing a color image in which each pixel has a red (R) value, a green (G) value, and a blue (B) value. The colorimetric value acquisition unit 202 acquires a plurality of colorimetric values (X, Y, Z) obtained by measuring the above-described color chart under the plurality of geometric conditions. The colorimetric value acquisition unit 202 acquires the plurality of colorimetric values from the colorimeter 116 and stores the acquired colorimetric values in the HDD 113. The geometric conditions for the imaging by the imaging apparatus 111 correspond to the geometric conditions for the measuring by the colorimeter 116.

The selection unit 203 selects data to be used to generate a color profile from among the plurality of pieces of image data and the plurality of colorimetric values stored in the HDD 113. The generation unit 204 generates the color profile based on the data selected by the selection unit 203.

### <Processing Performed by Image Processing Apparatus 1>

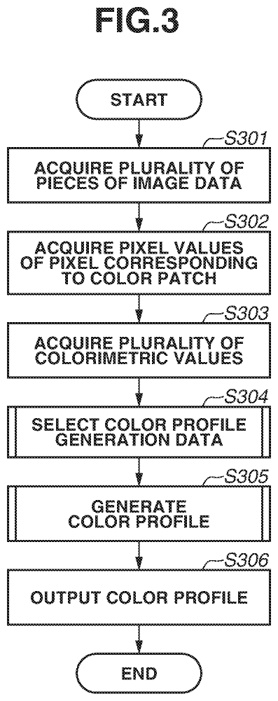

FIG. 3 is a flowchart illustrating processing performed by the image processing apparatus 1. Hereinafter, details of the processing by the image processing apparatus 1 is described with reference to FIG. 3. The processing illustrated in the flowchart of FIG. 3 is started when a user inputs an instruction via the input device 110 and the CPU 101 receives the input instruction. Hereinafter, each step is denoted by a reference numeral with a letter S.

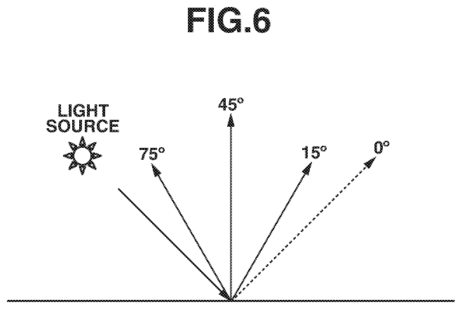

In step S301, the image data acquisition unit 201 acquires the plurality of pieces of image data obtained by imaging the color chart including the plurality of color patches each having a different color under the plurality of geometric conditions. FIG. 6 is a diagram illustrating the plurality of geometric conditions. Light is emitted from a light source located in a direction of 45 degrees with respect to a normal direction of each of the color patches, and a regular reflection direction of the light is regarded as zero degrees. In FIG. 6, the imaging apparatus 111 receives reflected light under three geometric conditions of 15 degrees, 45 degrees, and 75 degrees. The geometric condition is determined based on a normal direction of the color patch, an imaging direction of the color patch, and a direction in which a light source emits light to the color patch. The image data acquisition unit 201 according to the present exemplary embodiment acquires image data obtained by imaging the color chart under the three geometric conditions as illustrated in FIG. 6. While the geometric condition is changed by changing the imaging direction of the color patch in the example of FIG. 6, the geometric condition may be changed by changing the direction in which the light source emits light to the color patch. Further, both of the imaging direction of the color patch and the direction in which the light source emits light to the color patch may be changed. In the present exemplary embodiment, the plurality of color patches is imaged all at once; however, in a case where a large difference is caused to the geometric conditions of the color patches due to a large distance between the color patches in the color chart, each of the color patches is to be separately imaged under a different geometric condition. In the case where the plurality of color patches is imaged all at once as in the present exemplary embodiment, the difference in the geometric condition can be reduced by imaging from a position sufficiently away from the color chart, thereby reducing an imaging time.

In step S302, the image data acquisition unit 201 acquires pixel values of a pixel corresponding to the color patch from each of the images represented by the plurality of pieces of image data. The image data acquisition unit 201 according to the present exemplary embodiment displays the images on the display 115, and specifies the pixel at a position designated by the user as the pixel corresponding to the color patch. The pixel values of the specified pixel are stored in the HDD 113 in association with an identification (ID) for identifying the color patch and the geometric condition.

In step S303, the colorimetric value acquisition unit 202 acquires the plurality of colorimetric values obtained by measuring each of the color patches under the geometric condition that is the same as the geometric condition corresponding to each of the image data acquired by the image data acquisition unit 201. The colorimeter 116 that can output the device-independent color signal values is used in the measuring to obtain the colorimetric values. As the colorimeter 116, a multi-angle colorimeter or a non-contact colorimeter can be used. The colorimetric value acquisition unit 202 stores the acquired colorimetric values in the HDD 113 in association with the ID for identifying each of the color patches and the geometric condition.

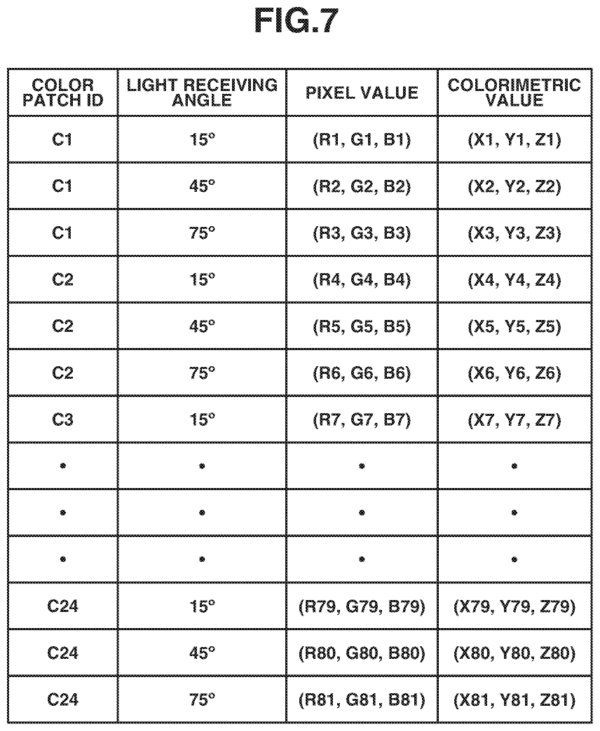

FIG. 7 illustrates the data stored in the HDD 113 in steps S302 and S303. FIG. 7 illustrates the data obtained by performing imaging and measuring on 24 types of color patches (C1 to C24) under the three geometric conditions (light receiving angle of 15 degrees, 45 degrees, and 75 degrees). Since three sets of correspondence relationship with respect to the pixel values (R, G, B) and the colorimetric values (X, Y, Z) are obtained for one color patch, data representing 81 sets of correspondence relationship for 24 types of color patches is obtained.

In step S304, the selection unit 203 selects data to be used to generate a color profile. Details of the processing to select the data to be used to generate the color profile is described below. In step S305, the generation unit 204 generates the color profile based on the data selected by the selection unit 203. Details of the processing to generate the color profile is described below. In step S306, the generation unit 204 outputs the generated color profile to the HDD 113.

### <Processing to Select Data to be Used to Generate Color Profile>

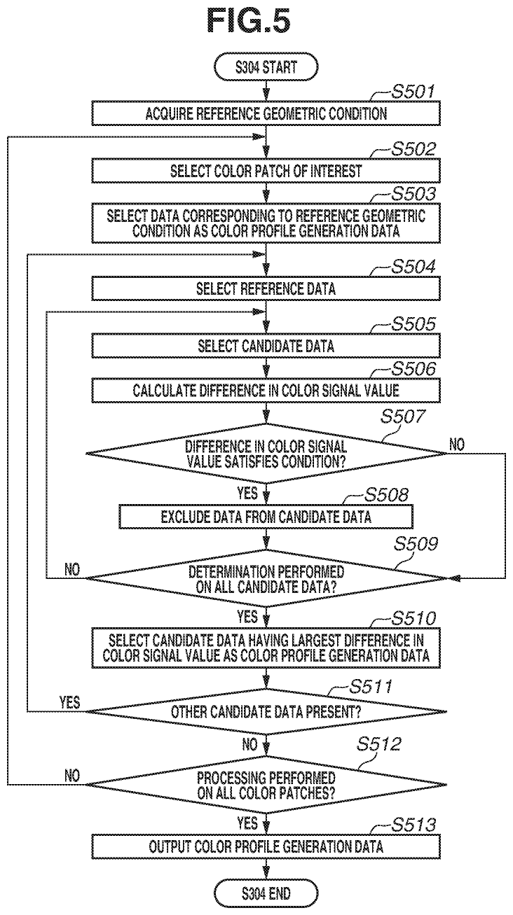

In step S304, the selection unit 203 selects the data to be used to generate the color profile. FIG. 5 is a flowchart illustrating the processing to select the data to be used to generate the color profile.

In step S501, the selection unit 203 acquires one of the plurality of geometric conditions under which the imaging and the measuring have been performed as a reference geometric condition. In the present exemplary embodiment, the light receiving angle of 45 degrees is defined as the reference geometric condition. In step S502, the selection unit 203 selects one of the plurality of color patches as a color patch of interest. In step S503, the selection unit 203 selects data of the color patch of interest corresponding to the reference geometric condition acquired in step S501 as color profile generation data.

In step S504, the selection unit 203 selects, from among the data of the color patch of interest, one piece of reference data to calculate a difference in color signal values between the data corresponding to the different geometric conditions. The initial reference data according to the present exemplary embodiment is data of the color patch of interest corresponding to the reference geometric condition acquired in step S501. In other words, in the present exemplary embodiment, data corresponding to the light receiving angle of 45 degrees is selected as the reference data. In step S505, the selection unit 203 selects one of the data of the color patch of interest corresponding to the geometric conditions different from the geometric condition of the reference data as candidate data to calculate the difference in the color signal value. In the present exemplary embodiment, data corresponding to the light receiving angle of 15 degrees or 75 degrees is selected as the candidate data.

In step S506, the selection unit 203 calculates the difference in the color signal values between the reference data and the candidate data. A specific example is described with reference to FIG. 7. In this example, the color patch C1 is selected in step S502, and the data corresponding to the light receiving angle of 15 degrees is selected as the candidate data in step S505. The RGB values corresponding to the color patch C1 and the light receiving angle of 15 degrees are (R1, G1, B1), and the XYZ values corresponding thereto are (X1, Y1, Z1). Further, the RGB values corresponding to the color patch C1 and the reference geometric condition are (R2, G2, B2), and the XYZ values corresponding thereto are (X2, Y2, Z2). The selection unit 203 calculates a difference ΔRGB of the RGB values from an expression (2), and calculates a difference ΔXYZ of the XYZ values from an expression (3).

[Expression 2]

ΔRGB=\sqrt{(R₁−R₂)²+(G₁−G₂)²+(B₁−B₂)²} (2)

[Expression 3]

ΔXYZ=\sqrt{(X₁−X₂)²+(Y₁−Y₂)²+(Z₁−Z₂)²} (3)

In step S507, the selection unit 203 determines whether the difference in the color signal values calculated in step S506 is lower than a threshold. More specifically, the selection unit 203 determines whether a condition that the difference ΔRGB is lower than the threshold or a condition that the difference ΔXYZ is lower than the threshold is satisfied. In a case where the condition that the difference ΔRGB is lower than the threshold or the condition that the difference ΔXYZ is lower than the threshold is satisfied (YES in step S507), the processing proceeds to step S508. In a case where the condition that the difference ΔRGB is lower than the threshold or the condition that the difference ΔXYZ is lower than the threshold is not satisfied (NO in step S507), the processing proceeds to step S509. To enhance color estimation accuracy near the geometric condition of the reference data, in one embodiment, the threshold is set to a small value; however, setting the small threshold makes it susceptible to a measurement error. Thus, an appropriate value is set in advance as the threshold.

In step S508, the selection unit 203 excludes the data satisfying the condition in step S507 from the candidate data. In step S509, the selection unit 203 determines whether the determination in step S507 has been performed on all of the data of the color patch of interest corresponding to the geometric conditions different from the geometric condition of the reference data. In a case where the determination in step S507 has been performed on all of the data of the color patch of interest corresponding to the geometric conditions different from the geometric condition of the reference data (YES in step S509), the processing proceeds to step S510. In a case where the determination in step S507 has not been performed on all of the data of the color patch of interest corresponding to the geometric conditions different from the geometric condition of the reference data (NO in step S509), the processing returns to step S505, and the data not selected yet is selected as the candidate data.

In step S510, the selection unit 203 selects, from among the candidate data, the candidate data in which a sum of the differences ΔRGB and ΔXYZ is the largest as the color profile generation data. Alternatively, the candidate data having the largest difference ΔRGB or the candidate data having the largest difference ΔXYZ may be selected as the color profile generation data. In step S511, the selection unit 203 determines whether the candidate data that has not been excluded in step S508 and has not been selected as the color profile generation data in step S510 is present. In a case where no such candidate data is present (NO in step S512), the processing proceeds to step S512. In a case where such candidate data is present (YES in step S511), the processing returns to step S504, and the data selected as the color profile generation data in step S510 is selected as the reference data.

In step S512, the selection unit 203 determines whether the processing has been performed on all of the color patches. If the processing has been performed on all of the color patches (YES in step S512), the processing proceeds to step S513. If the processing has not been performed on all of the color patches (NO in step S512), the processing returns to step S502, and the color patch of interest is updated. In step S513, the selection unit 203 outputs the data selected as the color profile generation data in step S503 and step S510 to the generation unit 204.

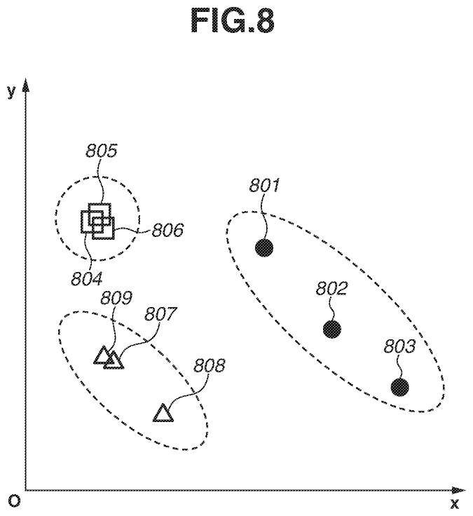

A specific example of the processing to select the data to be used to generate the color profile is described below with reference to FIG. 8. In FIG. 8, a point 801, a point 802, and a point 803 represent values on an xy chromaticity diagram obtained by measuring the color patch C1 at the light receiving angles of 15 degrees, 45 degrees, and 75 degrees, respectively. A point 804, a point 805, and a point 806 represent values on the xy chromaticity diagram obtained by measuring the color patch C2 at the light receiving angles of 15 degrees, 45 degrees, and 75 degrees, respectively. A point 807, a point 808, and a point 809 represent values on the xy chromaticity diagram obtained by measuring the color patch C3 at the light receiving angles of 15 degrees, 45 degrees, and 75 degrees, respectively. Herein, an example in which three pieces of color profile generation data are selected for the color patch C1, one piece of color profile generation data is selected for the color patch C2, and two pieces of color profile generation data are selected for the color patch C3 is described.

In the case of the color patch C1, firstly, data corresponding to the point 802 that represents a measurement value under the reference geometric condition is selected as the color profile generation data in step S503. Then, in step S505, data corresponding to the point 801 and data corresponding to the point 803 are selected as the candidate data. In step S507, it is determined that the difference in the color signal value between the data corresponding to the point 802 and the data corresponding to the point 801 and the difference in the color signal value between the data corresponding to the point 802 and the data corresponding to the point 803 are both larger than the threshold. The data corresponding to the point 801 is data having the largest difference in the color signal value with respect to the data corresponding to the point 802. Accordingly, in step S510, the data corresponding to the point 801 is selected as the color profile generation data. Next, the processing in steps S504 to S510 is performed using the data corresponding to the point 801 as the reference data, and the data corresponding to the point 803 is selected as the color profile generation data. As a result, all of the data corresponding to the three points 801 to 803 are selected as the color profile generation data.

In the case of the color patch C2, firstly, data corresponding to the point 805 that represents a measurement value under the reference geometric condition is selected as the color profile generation data in step S503. Then, in step S505, data corresponding to the point 804 and data corresponding to the point 806 are selected as the candidate data. In step S507, it is determined that the difference in the color signal value between the data corresponding to the point 805 and the data corresponding to the point 804 and the difference in the color signal value between the data corresponding to the point 805 and the data corresponding to the point 806 are both smaller than the threshold. In this case, no data is selected in step S510, and only the data corresponding to the point 805 is selected as the color profile generation data.

In the case of the color patch C3, firstly, data corresponding to the point 808 that represents a measurement value under the reference geometric condition is selected as the color profile generation data in step S503. Then, in step S505, data corresponding to the point 807 and data corresponding to the point 809 are selected as the candidate data. In step S507, it is determined that the difference in the color signal value between the data corresponding to the point 808 and the data corresponding to the point 807 and the difference in the color signal value between the data corresponding to the point 808 and the data corresponding to the point 809 are both larger than the threshold. The data corresponding to the point 809 is data having the largest difference in the color signal value with respect to the data corresponding to the point 808. Accordingly, in step S510, the data corresponding to the point 809 is selected as the color profile generation data. Next, the processing in steps S504 to S508 is performed using the data corresponding to the point 809 as the reference data, and the data corresponding to the point 807 is excluded from the candidate data in step S508. As a result, the data corresponding to the point 808 and the data corresponding to the point 809 are selected as the color profile generation data.

The above-described selection processing eliminates using all of the data obtained by measuring color and imaging to generate the color profile. This makes it possible to reduce the time necessary for the color profile generation processing. Further, since the data having the small difference in the color signal value with respect to the reference data is excluded from the candidate data, it is possible to generate the color profile stable against a measurement error.

### <Processing to Generate Color Profile>

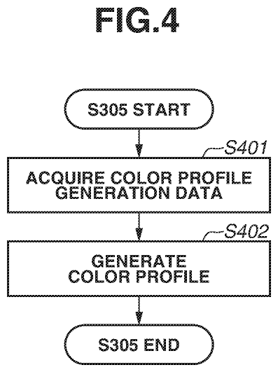

In step S305, the generation unit 204 generates the color profile based on the data selected by the selection unit 203. FIG. 4 is a flowchart illustrating the processing to generate the color profile.

In step S401, the generation unit 204 acquires the color profile generation data. In step S402, the generation unit 204 generates the color profile based on the acquired color profile generation data. More specifically, nine coefficients in a 3×3 matrix represented by the color profile are derived using the correspondence relationship between the RGB values and the XYZ values represented by the color profile generation data. The generation unit 204 derives the coefficients (a₁₁ to a₃₃) in the matrix in a following expression (4) so as to minimize an evaluation value E in an expression (5). In the expression (4) and the expression (5), 81 sets of the RGB values and the XYZ values illustrated in FIG. 7 are each represented by (Rᵢ, Gᵢ, Bᵢ) and (Xᵢ, Yᵢ, Zᵢ) (where i=1 to 81). The evaluation value E is a total sum of differences between the XYZ values (Xᵢ, Yᵢ, Zᵢ) and the XYZ values (Xᵢ′, Yᵢ′, Zᵢ′) derived by the expression (4).

$$\begin{matrix}[ Expression 4 ] & \\ [ \begin{matrix}{X}_{i}^{′} \\ {Y}_{i}^{′} \\ {Z}_{i}^{′}\end{matrix} ] = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] [ \begin{matrix}{R}_{i} \\ {G}_{i} \\ {B}_{i}\end{matrix} ] & ( 4 ) \\ [ Expression 5 ] & \\ E = {\sum }_{i} {E}_{i} = {\sum }_{i} \sqrt{{( {X}_{i}^{′} - {X}_{i} )}^{2} + {( {Y}_{i}^{′} - {Y}_{i} )}^{2} + {( {Z}_{i}^{′} - {Z}_{i} )}^{2}} & ( 5 )\end{matrix}$$

The coefficients can be derived through known optimization processing such as a least square method, a steepest descent method, a Newton method, and a DLS method.

### Effects by First Exemplary Embodiment

As described above, the image processing apparatus 1 acquires the plurality of device-dependent color signal values that is obtained by imaging at least one color patch under the plurality of geometric conditions, and the plurality of geometric conditions is based on the imaging direction of the color patch and the direction in which the light source emits light to the color patch. The image processing apparatus 1 acquires the plurality of device-independent color signal values obtained by measuring at least one color patch under the plurality of geometric conditions. The image processing apparatus 1 generates the color profile based on the plurality of device-dependent color signal values and the plurality of device-independent color signal values. As a result, it is possible to generate the color profile dealing with change in color appearance depending on an observation angle.

The image processing apparatus 1 according to the present exemplary embodiment outputs the generated color profile to the HDD 113; however, the image processing apparatus 1 may also perform color conversion using the generated color profile. In this case, the image processing apparatus 1 further includes a conversion unit. The conversion unit converts the device-dependent color signal values such as the RGB values of each pixel of the image into the device-independent color signal values such as the XYZ values based on the generated color profile. At this time, if pixel values of the image are saturated, an error can be caused due to the pixel values being clipped. Thus, it may be determined whether the pixel values of the image are saturated, and the above-described color conversion may be performed only when the pixel values of the image are not saturated. When the pixel values of the image are saturated, an error may be output.

The selection unit 203 according to the present exemplary embodiment calculates, as the difference in the color signal value, the sum of squares of differences of the RGB values and the sum of squares of differences of the XYZ values in step S506; however, the difference in the color signal value is not limited to the above-described example. For example, the difference in the color signal value may be a sum of absolute values of the differences. Further, the difference in the color signal value may be the minimum value, the maximum value, a median, or the like in the difference in the R value, the difference in the G value, and the difference in the B value. The difference in the color signal value may also be the minimum value, the maximum value, a median, or the like in the difference of the X value, the difference in the Y value, and the difference in the Z value. The difference in the color signal value may also be a difference Δxy of xy chromaticity value calculated by the following expression (6).

$$\begin{matrix}[ Expression 6 ] & \\ \begin{matrix}Δ xy = \sqrt{{( {x}_{1} - {x}_{2} )}^{2} + {( {y}_{1} - {y}_{2} )}^{2}} \\ x = \frac{X}{X + Y + Z} , y = \frac{Y}{X + Y + Z}\end{matrix} \} & ( 6 )\end{matrix}$$

The selection unit 203 according to the present exemplary embodiment selects the color profile generation data from the data of the same color patch under the different geometric conditions; however, the selection unit 203 may select the color profile generation data through comparison of the data of different color patches.

The image processing apparatus 1 according to the present exemplary embodiment includes the selection unit 203 that selects the color profile generation data; however, the image processing apparatus 1 may not include the selection unit 203. In this case, the color profile is generated using, as the color profile generation data, all of the data obtained by imaging and measuring color under the different geometric conditions.

In the present exemplary embodiment, the color profile is the data representing the nine coefficients in the 3×3 matrix; however, the color profile may have another form as long as the color profile represents the color conversion rule. For example, the color profile may be data representing coefficients in a 3×9 matrix or a 3×19 matrix. Further, the color profile is not limited to the data representing the coefficients in the matrix, and may be an LUT representing correspondence relationship between the RGB values (R, G, B) and the XYZ values (X, Y, Z). The LUT may be a 3DLUT or a 2DLUT.

In the present exemplary embodiment, the data illustrated in FIG. 7 is stored in the HDD 113, and the color profile is output to the HDD 113; however, the image processing apparatus 1 may further include a holding unit as a replacement for the HDD 113.

In the first exemplary embodiment, the color profile generation data is selected based on the difference in the color signal value obtained by imaging and measuring color under the different geometric conditions. In a second exemplary embodiment, the color profile generation data is selected using a color space that takes human visual characteristics into consideration. In a case where reflected light is received at a position near a regular reflection direction of light emitted from the light source, such as in the case of the light receiving angle of 15 degrees in FIG. 6, the pixel values may be saturated and may cause an error. This deteriorates accuracy of the color conversion using the color profile. Accordingly, in the present exemplary embodiment, an L*a*b* color space is used as the color space that takes human visual characteristics into consideration, and data causing deterioration of color conversion accuracy is not selected as the color profile generation data. A hardware configuration and a functional configuration of an image processing apparatus according to the present exemplary embodiment are similar to the hardware configuration and the functional configuration of the image processing apparatus 1 according to the first exemplary embodiment, whereby a description thereof is accordingly omitted. In the descriptions below, parts different between the present exemplary embodiment and the first exemplary embodiment are mainly described. The same components are described while being denoted by the same reference numerals.

### <Processing Performed by Image Processing Apparatus 1>

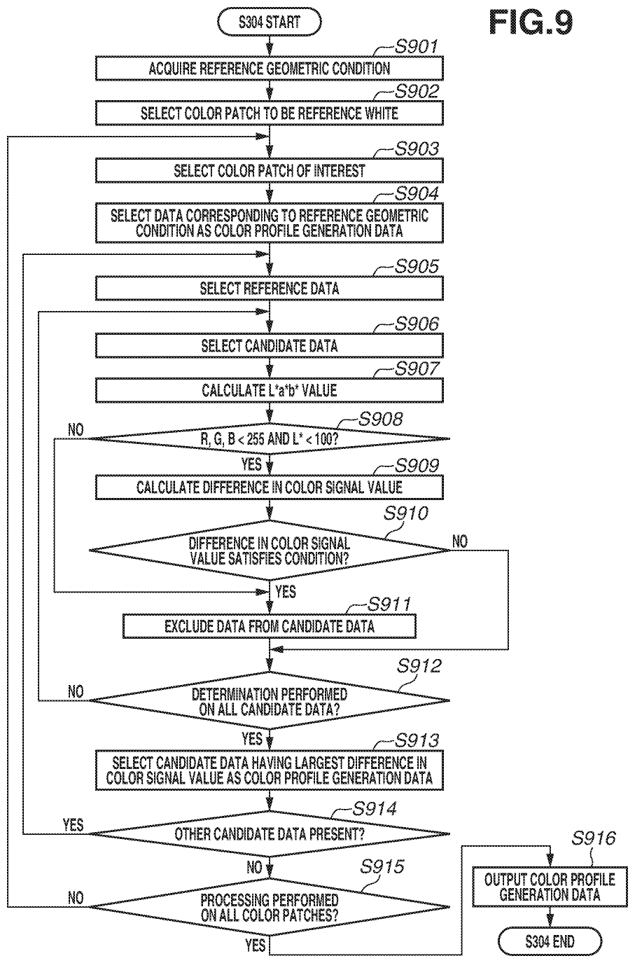

FIG. 9 is a flowchart illustrating processing performed by the image processing apparatus 1. Hereinafter, details of the processing performed by the image processing apparatus 1 is described with reference to FIG. 9. The processing illustrated in the flowchart of FIG. 9 is started when a user inputs an instruction via the input device 110, and the CPU 101 receives the input instruction. Hereinafter, each step is denoted by a reference numeral with a letter S.

In step S901, the selection unit 203 acquires one of the plurality of geometric conditions under which the imaging and the measuring have been performed as a reference geometric condition. In the present exemplary embodiment, the light receiving angle of 45 degrees is defined as the reference geometric condition. In step S902, the selection unit 203 selects a color patch to be a reference white for calculating L*a*b* values (L*, a*, b*) from among the plurality of color patches. The selection unit 203 according to the present exemplary embodiment displays the data illustrated in FIG. 7 on the display 115, and determines a color patch designated by the user as the color patch of the reference white. An ID of the color patch of the reference white may be previously determined. Further, the reference white may be determined by performing imaging and measuring separately from the imaging and the measuring of the color patch. The color patch of the reference white according to the present exemplary embodiment is the color patch having an ID of C24. In step S903, the selection unit 203 selects one of the plurality of color patches as a color patch of interest. In step S904, the selection unit 203 selects data of the color patch of interest corresponding to the reference geometric condition acquired in step S901 as the color profile generation data.

In step S905, the selection unit 203 selects, from the data of the color patch of interest, one piece of reference data to calculate difference in a color signal value among the data corresponding to the different geometric conditions. Initial reference data according to the present exemplary embodiment is data of the color patch of interest corresponding to the reference geometric condition acquired in step S901. In other words, in the present exemplary embodiment, data corresponding to the light receiving angle of 45 degrees is selected as the reference data. In step S906, the selection unit 203 selects one of the data of the color patch of interest corresponding to the geometric conditions different from the geometric condition of the reference data as the candidate data to calculate the difference of the color signal value. In the present exemplary embodiment, data corresponding to the light receiving angle of 15 degrees or 75 degrees is selected as the candidate data.

In step S907, the selection unit 203 calculates the L*a*b* values based on the XYZ values of the candidate data selected in step S906. In a case where the color patch of interest is C1 and the candidate data selected in step S906 is the data corresponding to the light receiving angle of 15 degrees, the L*a*b* values are obtained from the following expression (7) with use of the XYZ values corresponding to the light receiving angle of 15 degrees of the color patch C24, which is the reference white.

$$\begin{matrix}[ Expression 7 ] & \\ \begin{matrix}{L}^{*} = 116 [ f ( \frac{{Y}_{1}}{{Y}_{79}} ) - \frac{16}{116} ] \\ {a}^{*} = 500 [ f ( \frac{{X}_{1}}{{X}_{79}} ) - f ( \frac{{Y}_{1}}{{Y}_{79}} ) ] \\ {b}^{*} = 200 [ f ( \frac{{Y}_{1}}{{Y}_{79}} ) - f ( \frac{{Z}_{1}}{{Z}_{79}} ) ] \\ f ( x ) = {( x )}^{\frac{1}{3}} , where x > 0.008856 \\ f ( x ) = 7.787 x + \frac{16}{116} , where x \leq 0.008856\end{matrix} \} & ( 7 )\end{matrix}$$

In step S908, the selection unit 203 determines whether the color signal value of the candidate data selected in step S906 indicates a high-luminance signal. The determination is performed using the RGB values and the L*a*b* values. First, a determination method using the RGB values is described. For example, in a case where pixel values of each pixel of a captured image are the RGB values represented by eight bits, the maximum value of each of the RGB values is 255. Even if any of the RGB values is greater than 255, the value is clipped to 255. Thus, the RGB values may contain an error. Accordingly, the selection unit 203 determines whether each of the R value, the G value, and the B value is lower than 255. Next, a determination method using the L*a*b* values is described. A Commission Internationale de l'Éclairage (CIE) L*a*b* color space is a color space based on white, and a color brighter than the designated white cannot be evaluated. Accordingly, the selection unit 203 determines whether the L*a*b* values can be defined in the CIE L*a*b* color space, i.e., whether a condition that the L* value is lower than 100 is satisfied. In a case where the condition that each of the R value, the G value, and the B value is lower than 255 and the L* value is lower than 100 is satisfied in the candidate data selected in step S906 (YES in step S908), the processing proceeds to step S909. In a case where the condition that each of the R value, the G value, and the B value is lower than 255 and the L* value is lower than 100 is not satisfied (NO in step S908), the processing proceeds to step S911.

In step S909, the selection unit 203 calculates the difference in the color signal value between the reference data and the candidate data. At this time, as the difference in the color signal value, a color difference ΔE in the CIE L*a*b* color space is calculated. Further, the L*a*b* values of the reference data are also calculated by the expression (7) in a manner similar to the L*a*b* values of the candidate data. Where the L*a*b* values of the reference data are (L*i, a*i, b*i) and the L*a*b* values of the candidate data are (L*₂, a*₂, b*₂), the selection unit 203 calculates the color difference ΔE from an expression (8).

[Expression 8]

ΔE=\sqrt{(L₁^{*}−L₂^{*})²+(a₁^{*}−a₂^{*})²+(b₁^{*}+b₂^{*})²} (8)

The expression to calculate the color difference ΔE is not limited thereto, and an expression to calculate a difference ΔE94 or an expression to calculate a difference ΔE00 may be used.

Description of processing in steps S910 to S916 according to the present exemplary embodiment is omitted because the processing is similar to the processing in steps S507 to S513 according to the first exemplary embodiment.

### Effects by Second Exemplary Embodiment

As described above, the image processing apparatus 1 determines whether the color signal value is saturated and whether the color signal value is a value that can be defined in the CIE L*a*b* color space. As a result, it is possible to prevent data containing an error from being included in the color profile generation data and to generate the color profile dealing with change in color appearance depending on an observation angle.

According to the exemplary embodiments of the disclosure, it is possible to generate the color profile dealing with the change in color appearance depending on an observation angle.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-225343, filed Nov. 30, 2018, which is hereby incorporated by reference herein in its entirety.

What is claimed is:

1. An apparatus that generates a color profile to convert device-dependent color signal values into device-independent color signal values based on color signal values obtained by imaging and measuring a plurality of color patches, the apparatus comprising:
a first acquisition unit configured to acquire a plurality of device-dependent color signal values obtained by imaging at least one of the color patches under a plurality of geometric conditions, the plurality of geometric conditions being based on an imaging direction of each of the color patches and a direction in which a light source emits light to each of the color patches;
a second acquisition unit configured to acquire a plurality of device-independent color signal values obtained by measuring at least one of the color patches under the plurality of geometric conditions; and
a generation unit configured to generate the color profile based on the plurality of device-dependent color signal values and the plurality of device-independent color signal values.

2. The apparatus according to claim 1, wherein the generation unit generates the color profile based on a plurality of sets of the device-dependent color signal values and the device-independent color signal values that are obtained by imaging and measuring, respectively, one color patch under the plurality of geometric conditions.

3. The apparatus according to claim 1, wherein the imaging is performed by an imaging apparatus, and the measuring is performed by a colorimeter.

4. The apparatus according to claim 1, further comprising a selection unit configured to select color signal values to be used to generate the color profile from among the plurality of device-dependent color signal values, and select color signal values to be used to generate the color profile from among the plurality of device-independent color signal values,
wherein the generation unit generates the color profile based on the selected color signal values.

5. The apparatus according to claim 4, wherein the selection unit selects the color signal values to be used to generate the color profile based on a difference in color signal values corresponding to the different geometric conditions for each of the color patches.

6. The apparatus according to claim 5, wherein the selection unit selects the color signal values to be used to generate the color profile based on whether the difference in the color signal values is lower than a threshold.

7. The apparatus according to claim 4, wherein the selection unit determines a reference geometric condition for each of the color patches, and selects color signal values corresponding to the reference geometric condition as the color signal values to be used to generate the color profile.

8. The apparatus according to claim 7, wherein the selection unit selects the color signal values to be used to generate the color profile based on a difference between the color signal values corresponding to the reference geometric condition and color signal values corresponding to a geometric condition.

9. The apparatus according to claim 8, wherein the selection unit selects color signal values where the difference between the color signal values corresponding to the reference geometric condition and the color signal values corresponding to the geometric condition is maximum as the color signal values to be used to generate the color profile.

10. The apparatus according to claim 1, wherein the color profile is data representing coefficients in a matrix to convert the device-dependent color signal values into the device-independent color signal values.

11. The apparatus according to claim 1, wherein the color profile is a lookup table representing correspondence relationship between the device-dependent color signal values and the device-independent color signal values.

12. The apparatus according to claim 1,
wherein the first acquisition unit acquires a red (R) value, a green (G) value, and a blue (B) value as the device-dependent color signal values, and
wherein the second acquisition unit acquires an X value, a Y value, and a Z value as the device-independent color signal values.

13. The apparatus according to claim 1, wherein the device-independent color signal values acquired by the second acquisition unit are color signal values obtained by measuring at least one of the color patches by a multi-angle colorimeter.

14. The apparatus according to claim 1, wherein the device-independent color signal values acquired by the second acquisition unit are color signal values obtained by measuring at least one of the color patches by a non-contact colorimeter.

15. The apparatus according to claim 1, further comprising a conversion unit configured to convert the device-dependent color signal values into the device-independent color signal values with use of the generated color profile.

16. The apparatus according to claim 4, wherein the selection unit determines whether the color signal values are high-luminance color signal values, and selects the color signal values to be used to generate the color profile based on a result of determination.

17. The apparatus according to claim 4, wherein the selection unit determines whether the color signal values are saturated, and selects the color signal values to be used to generate the color profile based on a result of determination.

18. The apparatus according to claim 4, wherein the selection unit does not select color signal values representing a color brighter than reference white.

19. A method for generating a color profile to convert device-dependent color signal values into device-independent color signal values based on color signal values obtained by imaging and measuring a plurality of color patches, the method comprising:
acquiring a plurality of device-dependent color signal values obtained by imaging at least one of the color patches under a plurality of geometric conditions, the plurality of geometric conditions being based on an imaging direction of each of the color patches and a direction in which a light source emits light to each of the color patches;
acquiring a plurality of device-independent color signal values obtained by measuring at least one of the color patches under the plurality of geometric conditions; and
generating the color profile based on the plurality of device-dependent color signal values and the plurality of device-independent color signal values.

20. A non-transitory computer-readable storage medium storing instructions that, when executed by a computer, cause the computer to perform a method for generating a color profile to convert device-dependent color signal values into device-independent color signal values based on color signal values obtained by imaging and measuring a plurality of color patches, the method comprising:
acquiring a plurality of device-dependent color signal values obtained by imaging at least one of the color patches under a plurality of geometric conditions, the plurality of geometric conditions being based on an imaging direction of each of the color patches and a direction in which a light source emits light to each of the color patches;
acquiring a plurality of device-independent color signal values obtained by measuring at least one of the color patches under the plurality of geometric conditions; and
generating the color profile based on the plurality of device-dependent color signal values and the plurality of device-independent color signal values.
